(19) United States
(12) Patent Application Publication
(10) Pub. No.: US 2007/0121641 A1
(43) Pub. Date: May 31, 2007

(54) Method and system for network services with a mobile vehicle

(76) Inventors: Matthew N. Hovey, Royal Oak, MI (US); Mark A. D'Errico, Farmington Hills, MI (US)

Correspondence Address: ANTHONY LUKE SIMON;General Motors Corporation, Legal Staff, Mail Code 482-C23-B21, P.O. Box 300, Detroit, MI, 48265-3000, US

(21) Appl. No.: 11/255,372

(22) Filed: Oct. 21, 2005

(51) Int. Cl. H04L 12/56; G06F 15/16

(52) U.S. Cl. 370/395.2; 709/227

(57) ABSTRACT

A method for network services with a mobile vehicle comprising: initiating from a remote station a first connection session with a device in the mobile vehicle, wherein during the first connection session the device is notified of a pending command; and initiating a second connection session from the device in the mobile vehicle to the remote station in response to the first connection session, wherein the pending command is transmitted to the device in the mobile vehicle during the second session.

### TECHNICAL FIELD

This invention relates to a method and system for network services with a mobile vehicle.

### BACKGROUND OF THE INVENTION

A Web service typically refers to a category of interoperation between different software applications running on a variety of entities over a network. Web Service Description Language (WSDL) is an Extensible Markup Language (XML) format for describing network services as a set of endpoints, which are services, operating on messages containing document oriented or service oriented data.

In one known method, document oriented data is made available to software applications via Web servers. A Web server is a program that responds to web browsers as clients and utilize Hypertext Transport Protocol (HTTP) to serve files known as Web pages to the browsers.

It has been suggested to use web servers in mobile vehicles to provide Web services and exchange information into and out of the vehicles. In one example, Web servers within mobile vehicles would wait for requests for information or commands from remote entities. These remote entities may be personal computers, call centers, third party locations, or other vehicles. Including a Web server within a mobile vehicle increases cost, complexity, and computing cycles of the mobile vehicle computing entity as compared to other example communications methods.

### SUMMARY OF THE INVENTION

Advantageously, this invention provides a method and system for network services with a mobile vehicle.

Advantageously, according to one example, a method for network services with a mobile vehicle comprises: initiating from a remote station a first connection session with a device in the mobile vehicle, wherein during the first connection session the device is notified of a pending command; and initiating a second connection session from the device to the remote station in response to the first connection session, wherein the pending command is transmitted to the device in the mobile vehicle during the second session.

Advantageously, according to another example, a system for providing network services with a mobile vehicle comprises: a remote station coupled to a network, wherein the remote station initiates a first connection session to a mobile vehicle; a device within the mobile vehicle, wherein the first connection session is with the device and wherein, during the first connection session, the device is notified of a pending command; and a processor executing commands for controlling the device, initiating a second connection session from the device to the remote station in response to the first connection session, wherein the pending command is transmitted to the device within the mobile vehicle during the second session.

Advantageously, according to yet another example, a device within a vehicle for communication using network services comprises: a processor executing commands and communication hardware, wherein the processor executes control commands for at least first and second of connection sessions, wherein the device receives the first connection session initiated by a remote station, wherein during the first connection session the device is notified of a pending command, and wherein the device initiates a second connection session from the device to the remote station in response to the first connection session, wherein the pending command is transmitted to the device within the mobile vehicle during the second session.

### DESCRIPTION OF THE DRAWINGS

FIGS. 1a and 1b illustrate example sequence diagrams;

FIG. 2 depicts example structure of an encapsulated command solicitation message;

FIGS. 3a and 3b illustrate example command presence notification;

FIG. 4 illustrates an example command solicitation requests;

FIG. 5 illustrates an example structure of command delivery; and

FIG. 6 illustrates schematically example system components for delivery of network services to a vehicle suitable for use with the sequence shown in FIGS. 1a and 1b.

### DESCRIPTION OF AN EXEMPLARY EMBODIMENT

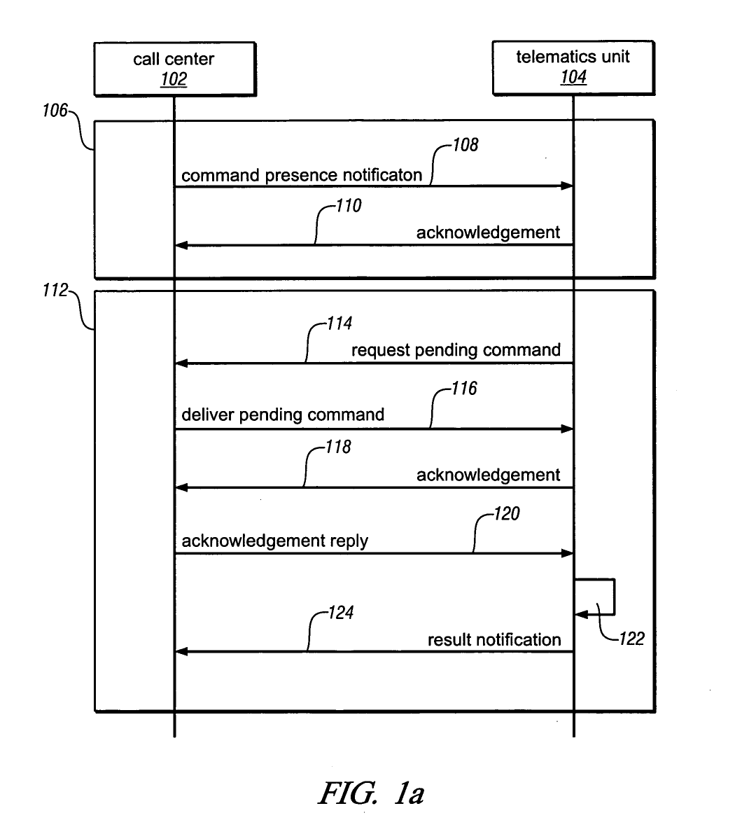

Referring to FIG. 1a and 1b, call center 102 communicates with a telematics unit 104 to deliver certain commands with two main steps. First, a command presence notification is established in a first session 106 initiated from the call center 102 to the vehicle telematics unit 104. Second, the pending command or commands are solicited by the vehicle in a second session 112 initiated by the telematics unit 104 responding to the first session from the call center.

Call center 102 may be any remote station for communicating with the vehicle over a network, including a telematics call center or third party facility, and may include a data center, maintenance facility, manufacturing facility, service facility and/or combinations thereof.

In the first session 106, a first service is used to establish communication with the vehicle. The first service preferably has attributes of being able to locate a vehicle on a nationwide network, communicate a short message and communicate a response from the vehicle.

In the first session 106, the command presence notification 108 alerts the telematics unit 104 of one ore more pending commands from the call center 102. The alert may be generic, having the sole purpose of signaling the presence of one or more pending commands. A pending command may include a data upload request where specific vehicle information such as vehicle location or maintenance data is to be uploaded from telematics unit 104 to the call center 102. In another example, the command presence notification may precede a download of information from the call center 102 to the telematics unit 104. Downloaded information may include new vehicle parameters or data such as powertrain control data, calibration data, weather and traffic information, navigation routes, personal calling replenishment minutes, diagnostic agents, and the like.

The command presence notification 108 is acknowledged by the telematics unit 104 via an acknowledgment message 110. The acknowledgement message informs the call center that the telematics unit 104 has successfully received the command presence notification 108 message.

In one example, the first session 106 is a Session Initiation Protocol (SIP) session, which allows the call center 102 to send a relatively simple message to the vehicle anywhere on the mobile wireless network. In general, SIP is a text based peer-to-peer protocol that facilitates the formation, modification, and execution of communication sessions between two or more participants also referred to as user agents. Interactions include peer-to-peer and multipoint communications.

A SIP network is comprised of five logical entities including a user agent, a proxy server, a redirect server, a registrar server, and a back-to-back user agent. Each entity has specific functions known to those skilled in the art and participates in a SIP communication as a client initiating requests or as a server responding to requests.

Each user agent is identified by an address, referred to as the SIP Uniform Resource Indicator or SIP URI that simulates an email address and is used for identification and location purposes. The SIP URI contains a user information (userinfo) field and a domain field. A user parameter is utilized to identify the userinfo field as a phone number or an IP (Internet Protocol) address. The SIP URI specifies the user agent's address and location on the network. The SIP specification is provided by the Internet Engineering Task Force (IETF) in RFC 3261, and is known to those skilled in the art.

After the acknowledgment message 110, the first connection session 106 ends (assuming no other business is required over that session) and the second connection session 112 is automatically initiated by the telematics unit 104. In one example for the second session, references 114, 116, 118, 120, and 124 represent communications utilizing Simple Object Access Protocol (SOAP) over Hypertext Transport Protocol (HTTP). SOAP is an XML protocol allowing applications to exchange information. An advantage of SOAP is that it allows applications to easily access Web services written in different implementation languages. SOAP, written in XML, represents data as text. For example, if a remote method requires an integer, string, array or other data structure, SOAP provides the mechanism for communicating with the remote method. Here the remote method may be a function, procedure, object, routine or sub-function running within telematics unit 104. The SOAP specification is provided by the W3C (World Wide Web Consortium) and is known and available to those skilled in the art.

HTTP may be used to communicate a SOAP message from one computing entity to another. SOAP is not restricted to using HTTP. For example, a SOAP message may be communicated using File Transfer Protocol (FTP), Simple Mailbox Transfer Protocol (SMTP) or Blocks Extensible Exchange Protocol (BEEP).

In FIG. 1a, the telematics unit 104 initiates a connection session and issues a request pending command signal 114 to the call center 102. The request pending command 114 signal indicates that the telematics unit 104 is ready to accept one or more new commands from the call center 102. In one example, the telematics unit 104 processor may reserve a portion of memory to retain and operate on the anticipated command.

The pending command or commands are transferred 116 from the call center 102 to the telematics unit 104. Commands may, for example, cause the telematics unit 104 to unlock doors, set personal comfort settings, query vehicle system components, request vehicle maintenance and system status, and receive, transfer and/or operate on new vehicle subsystem parameters. Commands may, in other examples, contain objects to be executed by the telematics unit 104, such as applets, applications or software updates.

The received pending command is acknowledged 118 by the telematics unit 104, which may take place immediately after receiving the pending command 116. An acknowledgement reply 120 is issued from the call center 102 responsive to the acknowledgement 118. The acknowledgement reply 120 verifies that the call center 102 has received the acknowledgement 118, allowing the call center 102 to anticipate a response regarding the result of the pending command.

The received command 116 is processed 122 by the telematics unit 104. Command processing 122 may be, for example, retrieval and activation of personalization settings such as seat positions and radio presets for a specific vehicle. A result notification 124 is issued from the telematics unit 104. The result notification 124 may indicate that the command was successfully processed, include status information and/or return values relevant to the processed command. In another example, the result notification 124 contains singular and/or bulk data responsive to the received command 116 and processing 120. Example result notification data includes individual discrete records, or may be records organized in a file structure. These records may come from an on-board diagnostic system or other on-board system.

Processing 126 may occur at the call center 102 responsive to the result notification 124. In one example, processing 126 comprises a computer program controlled examination of a script to determine if more pending commands are to be issued to the telematics unit 104. In another example further processing may include interaction with an advisor directing certain aspects of processing 126. In yet another example, an automaton may initiate executable computer code to determine if additional pending commands are to be issued to the telematics unit 104. Call center applications to process data from a vehicle, either automatically or with advisor participation, are known to those skilled in the art.

Responsive to the processing 126, the call center issues an acknowledgment 128 of the result notification 124. Depending upon the processing 126, a new command may or may not be included in the acknowledgement 128.

If a command is included in acknowledgment 128, telematics unit 104 issues an acknowledgement 130, to which the call center issues an acknowledgment reply 132. The acknowledgement reply 132 verifies that the call center 102 has received the acknowledgement 130 of the receipt of the pending command in the acknowledgment 128, allowing the call center 102 to anticipate a response regarding the result of the pending command. If no new command is included in acknowledgement 128, the session 112 is terminated.

The command with the acknowledgment 128 is processed 134 by the telematics unit 104. A result notification 136 is transmitted from the telematics unit 104 to the call center 102 for processing. If further commands are pending, then the commands are processed at the call center 102 and an acknowledgement reply with command is issued from the call center 102 to the telematics unit 104, repeating the process from acknowledgment 128 until commands from the call center 102 to the telematics unit 104 are completed. Otherwise, an acknowledgment reply 140 is issued and the session is terminated.

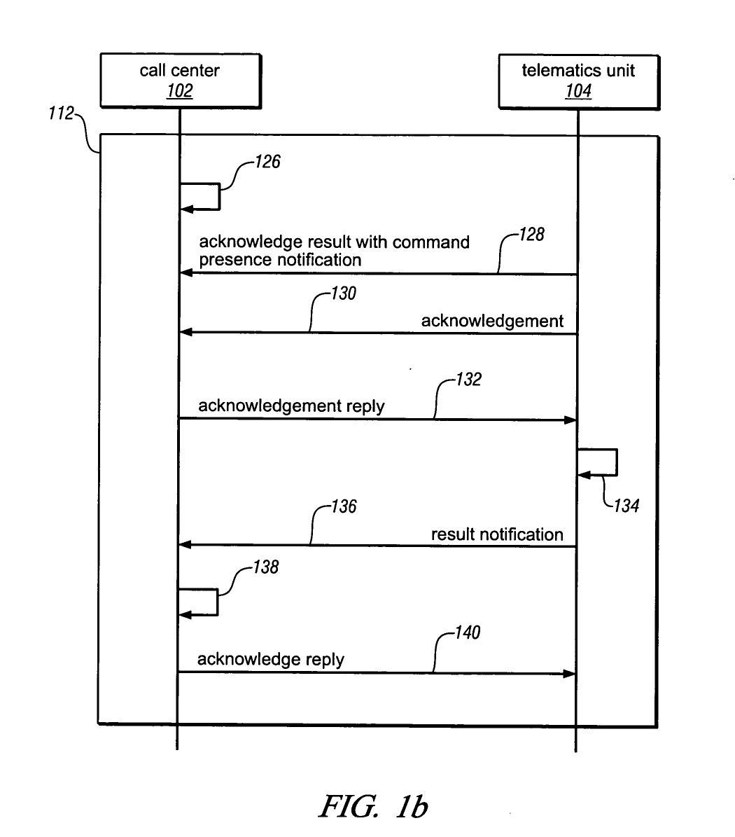

Referring now to FIG. 2, an HTTP message 202 encapsulates an HTTP header 204, and an HTTP body 206. Encapsulated within the HTTP body is a SOAP envelope 208, a SOAP header 210, and a SOAP body 212.

The SOAP envelope 208 is the root element of a SOAP message. The envelope has a namespace that defines which version of SOAP is being used for applications that interact with the message.

SOAP header 210 is encapsulated by the SOAP envelope 208. The information contained within a SOAP header 210 may relate to authentication, definitions of elements referred to in the SOAP body 212, a transaction, or other information.

SOAP body 212 is encapsulated by the SOAP envelope 210. The SOAP body 212 contains the data for either a receiving or sending application. In general, SOAP bodies 212 include a request, response, or a fault. A request contains a method name and associated input parameters. A response contains a method name and the output of the method. A fault contains a text string describing a fault.

In this example, the HTTP message 202 provides the transport mechanism to communicate the SOAP message from one computing entity to another. HTTP messages are stateless, wherein each transaction between computing entities are independent of any previous transaction. The HTTP header 204 contains request, response, and entity information. The request and response information is independent of SOAP requests and responses.

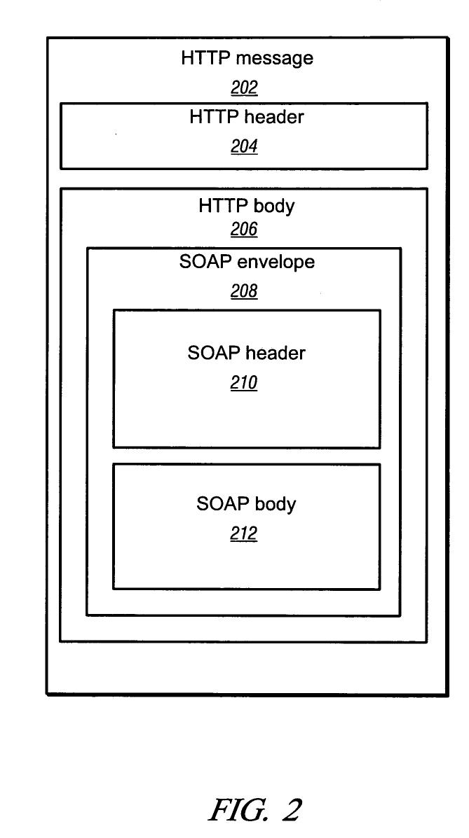

Referring to FIG. 3a, references 302 and 320 are components of a SIP message used to initiate a SIP session and notify a vehicle telematics unit of a pending command. The SIP header 302 contains a SIP session initiation information field 304. In this example, the SIP session initiation information field 304 contains a SIP INVITE method utilized to initiate a new SIP session.

The v or via field 306 indicates the SIP session utilizes TCP protocol at host port 111.111.222.222:5060. The f or from field 308 indicates the session source location. In this example, the session is sourced from cmdPresNotfy@services.entity.com, indicating a command presence notification.

The t or to field 310 indicates the entity with which to initiate a SIP session. In this example, the to field identifies the vehicle assigned the identifier 51693597. The i or call identification field 312 is a proxy, and, in this example, is labeled as 1000@entity.com.

The CSeq field 314 contains a value of 1 INVITE, indicating the sequence number and SIP method INVITE. A returned message from the SIP recipient, in this example the vehicle assigned the value of 51693597, will respond with the same CSeq number.

The c or content type field 316 indicates the type of session. In this example the content type 316 is an application. The l or length field 318 indicates the number of bytes to follow in the SIP message body 320. In this example, ninety-five bytes will follow the SIP header 302.

In the SIP body 320, the v or version field 322 provides a version of the SIP session. In this example, the version field 322 is set to zero.

The o or owner field 324 indicates the owner of the session. In this example, the owner of the session is the vehicle assigned the identifier 51693597. The other data elements in the owner field 324 are, respectively, the session identifier, the session version, an Internet indicator, Internet protocol version, and an Internet protocol address.

The session name 326 is CmdPresNotfy, an abbreviated tag for command presence notification. The c or connection information field 328 provides connection information, matching the Internet indicator, Internet protocol version and the Internet protocol address found in the owner field 324.

A t or time session field 330 is provided to indicate time constraints. In this example, a value of zero is provided, indicating no time constraint on the SIP session. An m or media description field 332 provides message information for the second session. In this example, the media description indicates the second session will be SOAP on port number 54344 transported over HTTPS (Hypertext Transport Protocol Secure).

Referring to FIG. 3b, reference 336 contains example command presence notification structure for a SIP message header inserted into a session already open. In this example, the SIP session initiation information field 338 contains a SIP NOTIFY data. SIP NOTIFY is used when a SIP session is previously established.

The v, f, t and i fields 340, 342, 344 and 346 all operate similarly to the fields 306, 308, 310 and 312, described above. CSeq field 348 contains a value of 1 NOTI, indicating the sequence number and SIP method NOTIFY. A returned message from the SIP recipient, in this example the vehicle assigned the value of 51693597, will respond with the same CSeq number. After c field 350, l or length field 352 contains a value of zero, indicating that no additional information is to follow.

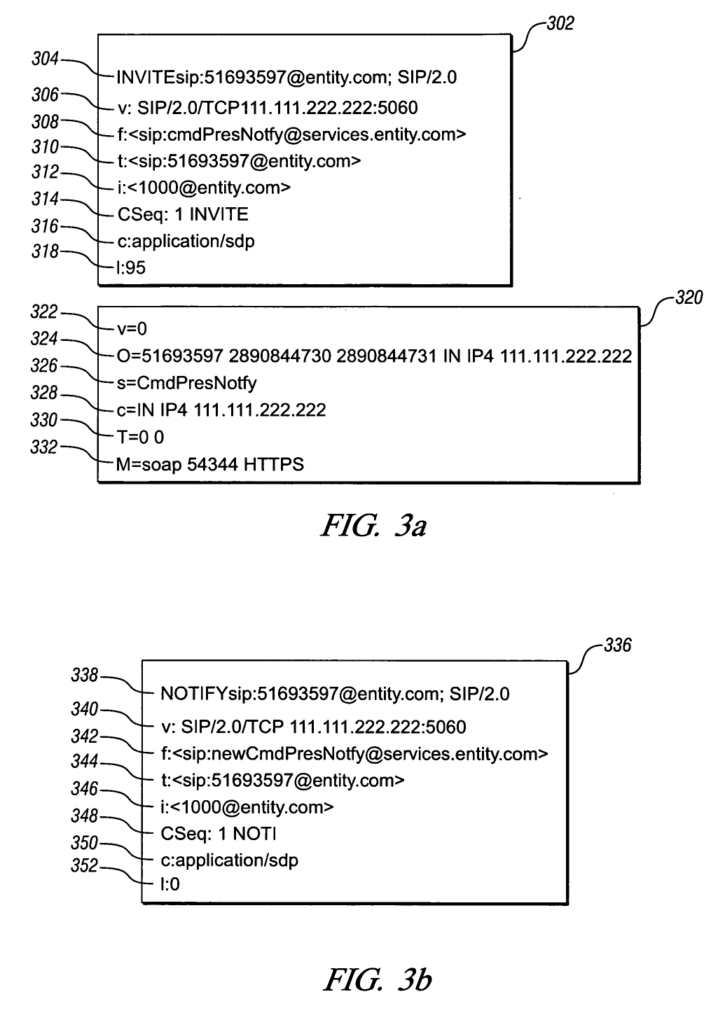

Referring now to FIG. 4, the example SOAP message illustrates structure for a vehicle message such as message 114 in FIG. 1a. SOAP envelope 402 contains the namespace
http://schemas.xmlsoap.org/soap/envelope/
   among others to alert a sending or receiving computing entity of the model, version and syntax of SOAP used to encode the SOAP message. The model, version, and syntax is referred to as the schema.

Section 404 indicates the beginning of the SOAP message body and section 406 indicates the method or content of the message. In this example, the method is identified as “AcceptPendingCommand” followed by a namespace field indicating where the method is defined.

ID element 408 includes the value 51693597, the identifier associated with the vehicle that the method, and hence the pending command, is intended for. Reference 410 indicates the end of the content portion of the SOAP message and reference 412 indicates the end of the body of the SOAP message, ending the SOAP message.

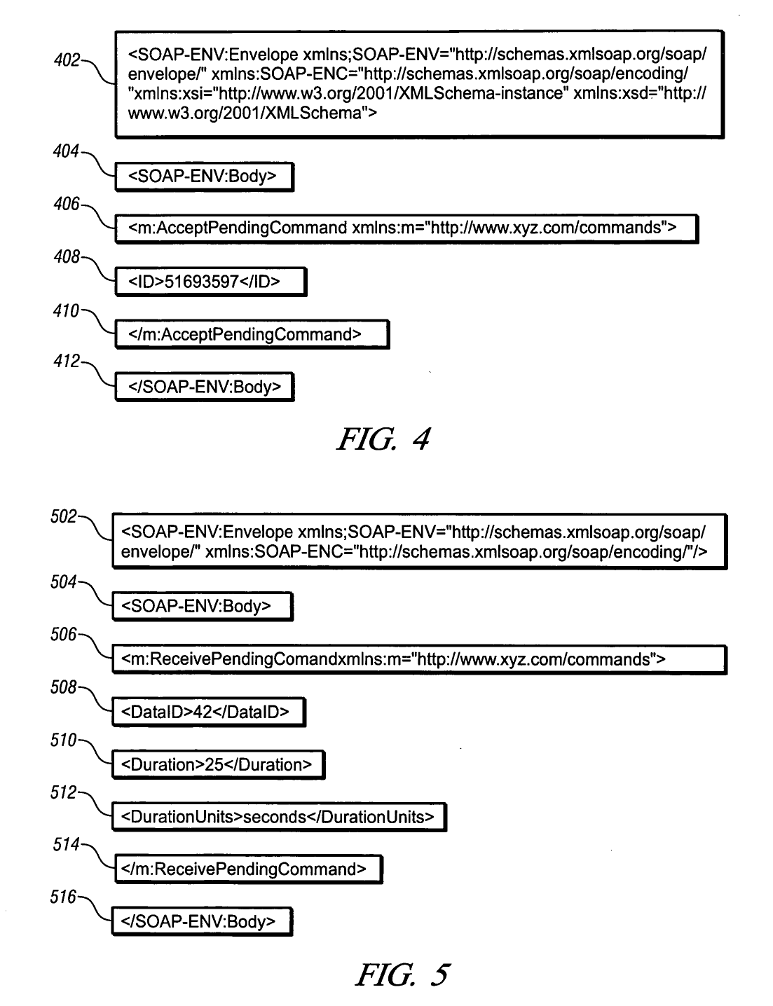

Referring to FIG. 5, an example SOAP command, such as for use with reference 116 in FIG. 1a, starts with the opening of the SOAP envelope 502. Reference 504 indicates the beginning of the body of the SOAP message and 506 indicates the beginning of the method, which contains the data for transport.

Data identifier 508 contains data for transport and, in this example, is the integer 42. In other examples, the data identifier may comprise a table, an array, a list, other set of parametric data, or object. In one example, the data identifier 42 may be a diagnostic code address or index. In another example, the data identifier 42 may be the identifier of a module resident within the vehicle, or a command to trigger a specific action by the telematics control unit.

Duration is provided in quantity 510 and units 512 to provide the proper temporal context. In this example, the units assigned to the duration element 510 are seconds. Thus, in this example the data identifier 508 value of 42 may represent a diagnostic code to monitor for a duration of 25 seconds.

References 514 and 516 represent closing of the data and body portions of the message, respectively.

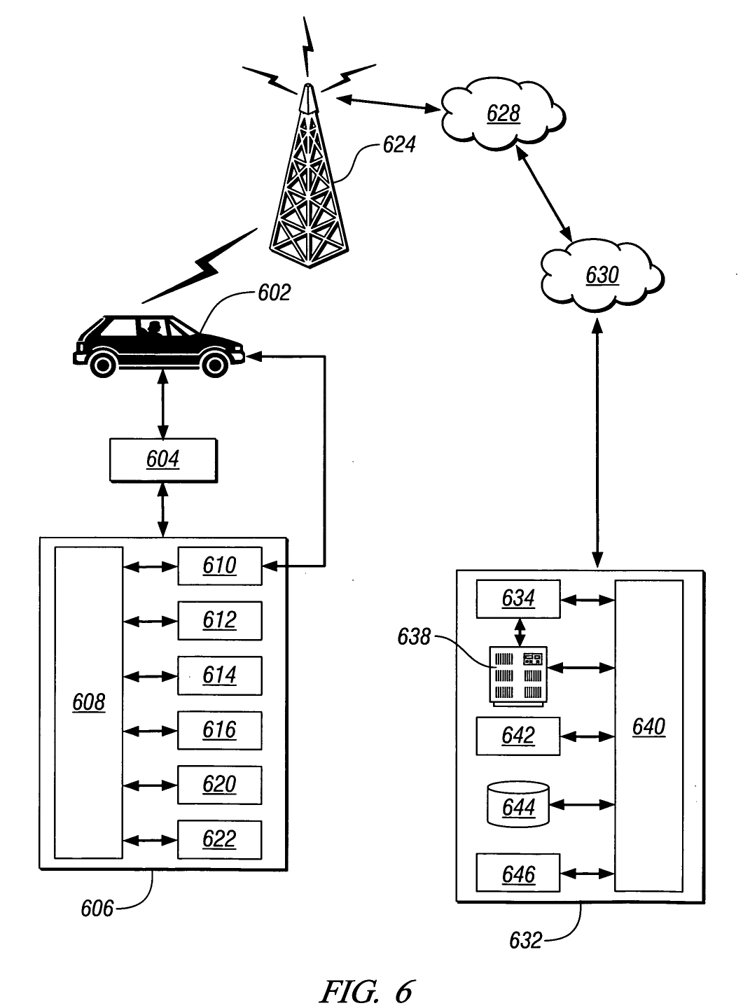

Referring now to FIG. 6, the system components shown schematically, include a vehicle 602, a vehicle communication bus 604, a telematics unit 606, a two-way radio frequency communication system (including but not limited to one or more wireless carrier systems 624, one or more communication networks 628, and/or one or more land networks 630), and one or more call centers 632. In one example, vehicle 602 is a mobile vehicle with suitable hardware and software for transmitting and receiving voice and data communications.

In an example, via vehicle communications bus 604, the vehicle sends signals from the telematics unit 606 to various units of equipment and systems within the vehicle 602 to perform various functions, such as, for example unlocking doors, and executing personal comfort settings. Communications bus 604 is comprised of interfaces such as, for example, a controller area network (CAN), ISO standard 11989 for high speed applications, ISO standard 11519 for lower speed applications, and/or Society of Automotive Engineers (SAE) standard J1850 for high speed and lower speed applications.

The telematics unit 606 may send and receive radio transmissions from wireless carrier 624. In one example, wireless carrier system 624 may be an analog or digital cellular telephone system for transmitting signals between the vehicle 602 and communications network 624. Further, the wireless carrier system 624 may include a cellular communication transceiver, a satellite communication transceiver, a wireless computer network transceiver (an example of which includes a wide area network (WAN) transceiver,) and/or combinations thereof.

Telematics unit 606 includes a processor 608 operatively coupled to a wireless modem 610 (which may be a hardware or software modem), a location detection system 612 (for example, a global positioning system (GPS)), an in-vehicle memory 614, a microphone 616, one or more speakers 620, and an embedded or in-vehicle compatible wireless network access device 622. These devices 606, 612, 614, 616, 620, and 622 may either be within or external to and operationally coupled with the telematics unit 606. For example, speakers 620 may be components of the vehicle audio system with which the telematics unit 606 interacts in a known manner.

Processor 608 may be a microcontroller, a controller, a microprocessor, a host processor, and/or vehicle communication processor. In another example, processor 608 may be an application specific integrated circuit (ASIC). Alternatively, processor 608 may be a processor working in conjunction with a central processing unit (CPU) performing the function of a general purpose processor.

If the telematics unit 606 includes a GPS receiver, the GPS receiver provides latitude and longitude coordinates of the vehicle 602 responsive to GPS broadcast signals received from a GPS satellite constellation (not shown). Other examples of the location detection system 612 include a radio triangulation system, a dead reckoning positioning system, and/or combinations thereof. The network access device 622 generally performs the communications capabilities of a wireless mobile phone of a known type, such as, for example, an analog cellular, digital, dual-mode, dual-band, multi-mode and/or multi-band cellular phone. Network access device 622 may include a separate processor (not shown).

Processor 608 may execute various computer programs that interact with operational modes of electronic and mechanical systems within the vehicle 602. It is to be understood that processor 608 controls communication (e.g., call signals) between the telematics unit 606, wireless carrier system 624, and the call center 632. The processor 608 executes commands and interacts with the modem 610 and mobile network access device 602. The processor 608 executes control commands for at least the two connection sessions described above with respect to FIGS. 1a and 1b. Under control of processor 608, the telematics unit 606 receives the first connection session initiated by a call center 632 during which the telematics unit 606 is notified of pending commands. In response to the notification, the processor 608 controls the telematics unit 606 to automatically initiate the second connection session from the telematics unit 606 to the remote station. During the second connection session, pending commands are requested and transmitted to the telematics unit 606 within the mobile vehicle.

Depending upon the requirements of the system designer taking into account the security needs for the communications with the telematics unit 606, various security techniques may be desirable. These techniques may include using encryption during communication, requiring authentication with a predetermined code or key, restricting the ports for communication, as well as the addresses that the telematics unit will talk to. Additionally, network filters can be put in place to prevent non-authorized source communications from reaching the vehicle. These and other security techniques are well known to those skilled in the art and are available to a system designer needing security features.

Further, processor 608 may generate and accept data transmitted between the telematics unit 606 and the vehicle communication network 604, which is connected to various electronic modules in the vehicle 602. In one example, these digital signals activate the programming mode within the electronic modules, as well as provide for data transfer between the electronic modules.

The communications network 624 may include services from one or more mobile telephone switching offices and/or wireless networks. Communications network 628 connects wireless carrier system 624 to land network 630. Communications network 624 may be any suitable system or collection of systems for connecting the wireless carrier system 624 to the vehicle 602 and the land network 630.

The land network 630 connects the communications network 628 to the call center 632. In one example, land network 630 is a public switched telephone network (PSTN). In another example, land network 630 is an Internet Protocol (IP) network. In still other examples, land network 630 is a wired network, an optical network, a fiber network, another wireless network, and/or combinations thereof. The land network 630 may be connected to one or more land line telephones. It is to be understood that the communication network 628 and the land network 630 connect the wireless carrier system to the call center 632.

Call center 632 contains one or more voice and/or data modems 634, one or more data switches 638, one or more communication service managers 642, one or more communication services databases 644 containing subscriber profile records and/or subscriber information, one or more communication service advisors 646, and one or more network systems 640.

Modem 634 in one example is directly connected to data switch 638. In another example, modem 634 communicates with data switch 638 via network 640. Modem 634 connects to land network 630. Modem 634 transmits voice and/or data transmissions from call center 632 and receives voice and/or data transmissions from telematics unit 606 in vehicle 602 through wireless carrier system 624, communications network 628, and land network 630. Switch 638 receives data transmissions from, or sends data transmissions to one or more communication service managers 642 via one or more network systems 640.

Call center 632 may contain one or more service advisors 646. In one example, service advisor 646 may be human. In another example, service advisor 646 may be an automaton.

While several examples have been described in detail, it will be apparent to those skilled in the art that the disclosed examples may be modified. Therefore, the foregoing description is to be considered exemplary rather than limiting.

1. A method for network services with a mobile vehicle comprising:
initiating from a remote station a first connection session with a device in the mobile vehicle, wherein during the first connection session the device is notified of a pending command; and
initiating a second connection session from the device to the remote station in response to the first connection session, wherein the pending command is transmitted to the device in the mobile vehicle during the second connection session.

2. The method of claim 1 wherein the first connection session utilizes a first network service protocol and the second connection session utilizes a second network service protocol different from the first network service protocol.

3. The method of claim 2 wherein the first network service protocol comprises Session Initiation Protocol.

4. The method of claim 1 wherein, during the first connection session, connection information for the second connection session is transmitted to the device in the mobile vehicle.

5. The method of claim 4 wherein the connection information for the second connection session includes a port.

6. The method of claim 2 wherein the second network service protocol is capable of transporting more information than the first network service protocol.

7. The method of claim 2 wherein the second network service protocol includes a text-based information transport function.

8. The method of claim 7 wherein the second network service protocol includes Simple Object Access Protocol.

9. The method of claim 8 wherein the Simple Object Access Protocol is transported within one of Hypertext Transport Protocol and Hypertext Transport Protocol Secure.

10. A system for providing network services with a mobile vehicle comprising:
a remote station coupled to a network, wherein the remote station initiates a first connection session to the mobile vehicle;
a device within the mobile vehicle, wherein the first connection session is with the device and wherein, during the first connection session, the device is notified of a pending command; and
a processor executing commands for controlling the device, initiating a second connection session from the device to the remote station in response to the first connection session, wherein the pending command is transmitted to the device within the mobile vehicle during the second connection session.

11. The system of claim 10 wherein the first connection session utilizes a first network service protocol and the second connection session utilizes a second network service protocol different from the first network service protocol.

12. The system of claim 11 wherein the first network service protocol comprises Session Initiation Protocol.

13. The system of claim 10 wherein, during the first connection session, connection information for the second connection session is transmitted to the device within the mobile vehicle.

14. The system of claim 13 wherein the connection information for the second connection session includes a port designation for communication with the remote station.

15. The system of claim 11 wherein the second network service protocol is capable of transporting more information than the first network service protocol.

16. The system of claim 11 wherein the second network service protocol includes a text-based information transport function.

17. The system of claim 16 wherein the second network service protocol includes Simple Object Access Protocol.

18. The system of claim 17 wherein the Simple Object Access Protocol is transported within one of Hypertext Transport Protocol and Hypertext Transport Protocol Secure.

19. A device within a vehicle for communication using network services comprising:
a processor executing commands and communication hardware,
wherein the processor executes control commands for at least first and second connection sessions,
wherein the device receives the first connection session initiated by a remote station, wherein during the first connection session the device is notified of a pending command, and
wherein the device initiates a second connection session from the device to the remote station in response to the first connection session, wherein the pending command is transmitted to the device within the mobile vehicle during the second connection session.

20. The device of claim 19 wherein, during the first connection session, connection information for the second connection session is transmitted to the device within the mobile vehicle.

21. A method for network services with a mobile vehicle comprising, in the mobile vehicle:
receiving at a device in the mobile vehicle a first connection session initiated by a remote station, wherein during the first connection session the device is notified of a pending command; and
initiating from the device a second connection session with the remote station in response to the first connection session, wherein the device receives the pending command in the mobile vehicle during the second connection session.

22. The method of claim 21 wherein the device receives the pending command after requesting the pending command from the remote station.
